(19) United States
(12) Patent Application Publication
(10) Pub. No.: US 2022/0205064 A1
(43) Pub. Date: Jun. 30, 2022

(54) RECOVERING MIXED-METAL IONS FROM AQUEOUS SOLUTIONS

(71) Applicant: CYTEC INDUSTRIES INC., Princeton, NJ (US)

(72) Inventors: William SZOLGA, JR., Ontario (CA); Troy Bednarski, Chandler, AZ (US); Boban Jakovljevic, Ontario (CA); Luis Moya, Tolleson, AZ (US)

(73) Assignee: CYTEC INDUSTRIES INC., Princeton, NJ (US)

(21) Appl. No.: 17/566,378

(22) Filed: Dec. 30, 2021

Related U.S. Application Data
(60) Provisional application No. 63/133,061, filed on Dec. 31, 2020.

(51) Int. Cl. C22B 47/00; C22B 7/00; H01M 10/54; C22B 3/00; C22B 26/12

(52) U.S. Cl. CPC C22B 47/00; C22B 7/007; C22B 26/12; C22B 23/0415; H01M 10/54

(57) ABSTRACT

Hydrometallurgical solvent extraction processes for recovering value metal ion species such as any of manganese, cobalt, nickel, and/or lithium from solutions derived from recycled electronics and/or batteries and containing mixed-metal ions by separating the value metal ions using selective stripping techniques as herein described, are provided.

### CROSS-REFERENCE TO RELATED APPLICATIONS

This application claims the benefit of U.S. Provisional Patent Application No. 63/133,061, filed Dec. 31, 2020, the entirety of which is hereby incorporated by reference.

### TECHNICAL FIELD

The disclosure generally relates to hydrometallurgical solvent extraction processes for extracting value metal ions from aqueous solutions. More particularly, the disclosure relates to such processes for recovering value metal ions from recycled electronics and battery process streams.

### BACKGROUND

With the increased use of lithium-ion (“Li-ion”) batteries for powering a multitude of various electronic devices and electric vehicles, several processes have been developed and/or commercialized in an attempt to efficiently recover value metals from such recycled materials.

Pyrometallurgical processes can be applied to a variety of Li-ion battery types and can be used on whole cells/modules directly with little to no pretreatment. Pyrometallurgical processes use a high-temperature furnace to reduce the metals contained in the spent battery to an alloy of cobalt, copper, iron and nickel. Other metals and/or impurities move to the slag phase or form gases. The metal alloy can be further processed using hydrometallurgical methods to isolate individual metals. These processes are described by, for example, U.S. Pat. Nos. 7,169,206 and 8,840,702.

Alternatively, batteries can subjected to mechanical processing by crushing or shredding to produce a size-reduced feed stream. Pretreatment to discharge the battery can be used to improve the safety of the process. The stream following mechanical processing can be further refined by exploiting properties such as particle size, magnetism, density, and hydrophobicity to recover specific material fractions. The fraction containing the cathode and anode materials is commonly referred to in the art as “black mass”.

Hydrometallurgical treatment can then be applied for the separation and refining of the black mass contents. Aqueous solutions can be used to dissolve or “leach” the desired metals from the cathode material. A wide range of inorganic acids have been tested as leaching agents, including hydrochloric acid, sulfuric acid, nitric acid, and phosphoric acid. A reducing agent can be added to reduce cobalt and manganese in the cathode material. Sulfuric acid and hydrogen peroxide are, respectively, the most common leaching agent and reducing agent.

Metals such as manganese, cobalt, nickel, and lithium can be recovered from the leach solution directly by precipitation or crystallization. This can be accomplished without first separating the metals into single-component streams, as described in U.S. Patent Application Publication No. 2020/078796.

Additional processing steps using solvent extraction or ion exchange may be used to obtain pure metal compounds. The use of solvent extraction processes to isolate aluminum, copper, manganese, cobalt, nickel, and/or lithium in separate streams has been described previously, e.g., in U.S. Patent Application Publication No. 2020/0140972 and in Int'l Publication No. WO 2020/124130. However, such process designs and/or operating parameters for the leaching, precipitation, and/or solvent extraction steps are deficient in achieving the strict product purity requirements of battery-grade metal salts, particularly if the process is to be part of a circular economy and achieve a high sustainability index rating.

Accordingly, the processes presently available for separation and recovery of value metal ions from feedstocks such as recycled Li-ion batteries require further improvement, and the industry and/or consumer have a need for a useful commercial alternative, thereby hastening greater adoption of electric vehicles. Sustainable processes that effectively contribute to a circular economy by providing a means for achieving suitable purity for the production of battery-grade metal salts from recycled feedstocks would be a useful advance in the art and could find rapid acceptance in the industry.

### SUMMARY

The forgoing and additional objects are attained in accordance with the principles set forth in the present disclosure, wherein the inventors describe in detail for the first time a multi-stage leaching process of a substrate containing a plurality of metals, whereby impurities (e.g., non-value metals) are selectively separated from a multi-metal leachate solution. Individual value metals can then be better isolated from the multi-metal solution that has had impurities reduced/depleted therefrom by flowing the multi-metal solution through sequential solvent extraction circuits, wherein selective stripping is used to effectively further limit the transfer of impurities that pass along with the metals between the solvent extraction circuits. Use of selective stripping in the sequential solvent extraction circuits advantageously improves the robustness of the process and allows for consistently high yield and high purity of value metals from changing feed concentrations and/or impurity levels. Accordingly, the processes according to various embodiments of the present disclosure as described herein below for recovering individual value metals from a mixed-metal substrates from various feedstocks such as recycled Li-ion batteries are applicable for use in obtaining battery precursors (i.e., battery-grade metal salts) meeting the strict purity requirements of battery manufacturers.

Accordingly, in one aspect the present disclosure provides hydrometallurgical solvent extraction processes including:

intermixing an aqueous acidic feed stream comprising mixed metal ions with an organic solvent comprising a first metal extraction reagent that is selective to binding a first target metal ion species, to extract the first target metal ion species into the organic solvent and obtain a loaded organic solvent comprising the first target metal ion species and one or more non-target metal ion species;

selectively stripping the loaded organic solvent, wherein selectively stripping the loaded organic solvent comprises

intermixing the loaded organic solvent with a second aqueous acidic strip solution at a second pH, to transfer the first target metal ion species from the loaded organic solvent to the second aqueous acidic strip solution, and

i) prior to intermixing the loaded organic solvent with the second aqueous acidic strip solution, intermixing the loaded organic solvent with a first aqueous acidic strip solution at a first pH that is greater than the second pH, to transfer a first non-target metal ion species of the one or more non-target metal ion species to the first aqueous acidic strip solution, or

ii) subsequent to intermixing the loaded organic solvent with the second aqueous acidic strip solution, intermixing the loaded organic solvent with a third aqueous acidic strip solution at a third pH that is less than the second pH, to transfer a second non-target metal ion species of the one or more non-target metal ion species to the third aqueous acidic strip solution, or

iii) both (i) and (ii); and

recovering said first target metal ion species from the second aqueous acidic strip solution by any suitable means.

Embodiments of this and other hydrometallurgical solvent extraction processes can have any one or more of at least the following characteristics.

In some embodiments, the hydrometallurgical solvent extraction process includes: (a) intermixing the loaded organic solvent with the first aqueous strip acidic solution at the first pH selectively removes the first non-target metal ion species compared to at least one of the first target metal ion species or the second non-target metal ion species, or (b) intermixing the loaded organic solvent with the third aqueous acidic solution at the third pH selectively removes the second non-target metal ion species compared to at least one of the first target metal ion species or the first non-target metal ion species, or both (a) and (b).

In the same or other embodiments of the hydrometallurgical solvent extraction process the second pH can be at least 0.5 less than the first pH, or the second pH can be at least 0.5 more than the third pH, or the second pH can be both at least 0.5 less than the first pH, and at least 0.5 more than the third pH.

In certain embodiments, the second pH is from 0 to 2, and the first pH is from 2 to 5, or the third pH is from −0.8 to 1, or the first pH is from 2 to 5 and the third pH is from −0.8 to 1.

In other embodiments, the second pH is between 2 and 5, and the first pH is between 5 and 6, or the third pH is between −0.5 and 3, or the first pH is between 5 and 6, and the third pH is between −0.5 and 3.

In still other embodiments, the second pH is between 1.5 and 5, and the first pH is between 5.5 and 7, or the third pH is between 1 and 4, or the first pH is between 5.5 and 7, and the third pH is between 1 and 4.

In yet other embodiments, the second pH is between 1.5 and 7, and the first pH is between 10 and 12, or the third pH is between 1 and 6, or the first pH is between 10 and 12, and the third pH is between 1 and 6.

In the same or additional embodiments, the aqueous acidic feed stream of mixed-metal ions is derived from recycled electronics and/or battery materials comprising one or more of manganese, cobalt, nickel, and/or lithium metal ions.

In any of the foregoing or additional embodiments, the first target metal ion species includes manganese, and the first non-target metal ion species includes copper, or the second non-target metal ion species includes at least one of iron or aluminium, or the first non-target metal ion species includes copper, and the second non-target metal ion species includes at least one of iron or aluminium.

In other embodiments, the first target metal ion species includes cobalt, and the first non-target metal ion species includes at least one of nickel, lithium, calcium, sodium, or ammonium, or the second non-target metal ion species includes at least one of manganese or copper, or the first non-target metal ion species includes at least one of nickel, lithium, calcium, sodium, or ammonium, and the second non-target metal ion species includes at least one of manganese or copper.

In other embodiments, the first target metal ion species includes nickel, and the first non-target metal ion species includes cobalt; or the second non-target metal ion species includes at least one of copper, aluminum, or iron; or the first non-target metal ion species includes cobalt, and the second non-target metal ion species includes at least one of copper, aluminum, or iron.

In still other embodiments, the first target metal ion species includes lithium, and the first non-target metal ion species includes at least one of sodium or ammonium, or the second non-target metal ion species includes at least one of nickel or calcium, or the first non-target metal ion species includes at least one of sodium or ammonium, and the second non-target metal ion species includes at least one of nickel or calcium.

In any of the foregoing or additional embodiments, a loading capacity of the first metal extraction reagent is less than 70%.

In the same or other embodiments, recovering the first target metal ion species includes crystallizing a sulfate hydrate product out of the second aqueous acidic strip solution.

In any or all embodiments, the first metal extraction reagent includes an organophosphorus compound. In certain implementations, the organophosphorus compound includes di-(2-ethylhexyl)phosphoric acid.

In any or all embodiments the hydrometallurgical solvent extraction process includes, subsequent to intermixing the aqueous acidic feed stream with the organic solvent having the first metal extraction reagent, intermixing the aqueous acidic feed stream with a second organic solvent having a second metal extraction reagent that is selective to binding a second target metal ion species, to extract the second target metal ion species into the second organic solvent, wherein intermixing with the second organic solvent is conducted at a higher pH than intermixing with the organic solvent.

In any or all embodiments, the process further includes obtaining the aqueous acidic feed stream comprising mixed-metal ions by:
performing a primary leach of black mass solids, wherein metal ion impurities are selectively leached from the black mass solids into a first leaching solution; performing first solid/liquid separation of the black mass solids and the first leaching solution;
performing a secondary leach of the black mass solids, wherein value metal ions are selectively leached from the black mass solids into a secondary leaching solution; and performing second solid/liquid separation of the black mass solids and the secondary leaching solution, to isolate the secondary leaching solution enriched in the value metal ions.

In any or all embodiments, the process may further include removing metal ion impurities including at least one of iron, copper, or aluminium from the aqueous acidic feed stream by at least one of:
precipitating the metal ion impurities from the aqueous acidic feed stream as metal hydroxides and separating the precipitated metal hydroxides from the aqueous acidic feed stream by filtering, or
intermixing the aqueous acidic feed stream with a second organic solvent including a metal extraction reagent that is selective to binding the metal ion impurities, so transfer the metal ion impurities into the second organic solvent.

In any or all embodiments, the process may further include, prior to selectively stripping the loaded organic solvent, intermixing the loaded organic solvent with a scrubbing solution having at least one of sulfuric acid or a sulfate of the first target metal ion species; and removing one or more metal ion impurities from the loaded organic solvent intermixed with the scrubbing solution.

In any or all embodiments, the process further includes providing the loaded organic solvent for further solvent extraction after extraction of the first target metal ion species and the one or more non-target metal ion species from the loaded organic solvent.

In another aspect, the disclosure provides processes for extracting target metal ion species from at least one of recycled electronics or battery materials by:

obtaining a leach solution having manganese ions, cobalt ions, nickel ions, and lithium ions, wherein the leach solution is derived from the at least one of recycled electronics or battery materials dissolved with at least one of acid or a reducing agent;

separating the manganese ions from the leach solution in a first multi-stage hydrometallurgical solvent extraction process using a first organic solution and conducted at a first pH;

subsequent to separating the manganese ions from the leach solution, separating the cobalt ions from the leach solution in a second multi-stage hydrometallurgical solvent extraction process using a second organic solution and conducted at a second pH that is higher than the first pH;

subsequent to separating the nickel ions from the leach solution, separating the lithium ions from the leach solution in a fourth multi-stage hydrometallurgical solvent extraction process using a fourth organic solution and conducted at a fourth pH that is higher than the third pH.

In the same or other embodiments, the first pH is between 2 and 4, the second pH is between 4 and 6, the third pH is between 5 and 7, and the fourth pH is between 9 and 12.

In any or all embodiments, the first organic solution includes di-(2-ethylhexyl)phosphoric acid, or the second organic solution includes bis(2,4,4-trimethylpentyl)phosphinic acid; or the third organic solution includes carboxylic acid compound; or the fourth organic solution includes a phosphine oxide and a proton donating agent; or a combination of any of the foregoing organic solutions. In certain embodiments, the proton donating agent can be a ketone. In the same or other embodiments, the ketone can be a beta-diketone, for example.

In any or all embodiments, separation of the manganese ions, cobalt ions, nickel ions, and lithium ions is conducted with metal loading capacities of metal extraction reagents of less than 70%.

In any or all embodiments the solvent extraction process can further include converting at least one of the manganese ions, cobalt ions, nickel ions, or lithium ions into a metal salt form by crystallization.

In any or all embodiments, the solvent extraction process can further include scrubbing at least one of the first organic solution, the second organic solution, the third organic solution, or the fourth organic solution following respective metal ion separation processes, wherein the scrubbing comprises intermixing the respective organic solution with a scrubbing solution comprising at least one of sulfuric acid or a metal sulfate.

In certain implementations, the metal sulfate is derived from an evaporative crystallization bleed stream or a bleed stream from a stripping process.

In any or all embodiments, the solvent extraction process can include controlling pH levels of the leach solution from the first pH, to the second pH, to the third pH, and to the fourth pH by flowing one or more bases into the leach solution. In the same or other embodiments, the solvent extraction process can include recovering at least one of sodium ions, ammonium ions, or calcium ions from the leach solution after separation of the lithium ions, by performing evaporative crystallization on the leach solution to yield at least one of sodium sulfate salts ammonium sulfate salts, or calcium sulfate salts.

In any or all embodiments, the solvent extraction process can include obtaining water as a product of the evaporative crystallization; and providing the water as a base for generation of subsequent leach solution of additional black mass.

In some embodiments, the value metal ions recovered have an ionic purity of at least 98% or 99%; preferably greater than 98%; preferably greater than 99%, as measured by inductively coupled plasma mass spectrometry (ICP).

Aspects of this disclosure can be implemented to realize one or more advantages. In some implementations, target metal extraction by solvent extraction and/or selective stripping can produce fewer undesired by-products compared to some alternative methods (e.g., production of toxic gases in some pyrometallurgical processes). In some implementations, target metal extraction by solvent extraction and/or selective stripping can be performed at a reduced energy cost compared to some alternative methods, e.g., by being performed at relatively low temperatures. In some implementations, target metal extraction by solvent extraction and/or selective stripping can increase a purity of extracted target metals (e.g., achieving an ionic purity of at least 98% or 99%; preferably greater than 98%; preferably greater than 99%, as measured by inductively coupled plasma mass spectrometry (ICP)), and/or a proportion of target metals that are extracted, e.g., due to particular sequences of pH values used for target metal extraction and isolation. In some implementations, extraction of high-purity value metals allows for the metals' re-use in new electronic devices, providing improved environmental performance. In some implementations, solvent consumption can be reduced by re-use of solvents such as water and/or organic solvents, improving sustainability of metal extraction processes and reducing costs.

This summary of the disclosure does not list all necessary steps, characteristics, elements or advantages of the disclosure and, therefore, subcombinations of these steps, characteristics or elements may also constitute part of the present disclosure. Accordingly, these and other objects, features and advantages of this disclosure will become apparent from the following detailed description of the various embodiments of the disclosure taken in conjunction with the accompanying figures.

### BRIEF DESCRIPTION OF THE DRAWINGS

FIG. 1 is a diagram illustrating an example process for recovering value metal ions from feedstock.

FIG. 2 is a diagram illustrating an example selective stripping process.

### DETAILED DESCRIPTION

The present disclosure generally relates to recovery of value metals from mixed-metal solutions. In some embodiments, the disclosure describes processes for recovering, in high yield and in high purity, individual value metal ions from aqueous acidic solutions (such as leachate solutions) containing mixed-metal ions by flowing such solutions through sequential solvent extraction circuits that effectively mitigate the transfer of impurity metals (e.g., non-value or non-target metals) between unit operations. The processes described herein provide improvements and unexpected advantages when compared to existing processes and achieve suitable purities of battery-grade metal salts that are desirable to battery precursor manufacturers, or for other suitable uses.

As employed throughout this disclosure, the following terms are provided to assist the reader. Unless otherwise defined, all terms of art, notations and other scientific or industrial terms or terminology used herein are intended to have the meanings commonly understood by those of skill in the chemical and/or solvent extraction and/or battery recycling/production arts. In some cases, terms with commonly understood meanings are defined herein for clarity and/or for ready reference, and the inclusion of such definitions herein should not necessarily be construed to represent a substantial difference over the definition of the term as generally understood in the art unless otherwise indicated. As used herein and in the appended claims, the singular forms include plural referents unless the context clearly dictates otherwise. Throughout this specification, the terms retain their definitions.

As used herein, the term “black mass” shall refer to material that is obtained following mechanical/physical separation of recycled electronics and/or batteries containing mixed-metals.

The terms “comprised of,” “comprising,” or “comprises” as used herein includes embodiments “consisting essentially of” or “consisting of” the listed elements, and the terms “including” or “having” should be equated with “comprising.”

Those skilled in the art will appreciate that while preferred embodiments are discussed in more detail below, multiple embodiments of the systems and processes described herein are contemplated as being within the scope of the present disclosure. Thus, it should be noted that any feature described with respect to one aspect or one embodiment of the disclosure is interchangeable and/or combinable with another aspect or embodiment of the disclosure unless otherwise stated. It will be understood by those skilled in the art that any description of the disclosure, even though described in relation to a specific embodiment or drawing, is applicable to and interchangeable with other embodiments of the present disclosure.

Furthermore, for purposes of describing embodiments of the present disclosure, where an element, step, component, or feature is said to be included in and/or selected from a list of recited elements, steps, components, or features, those skilled in the art will appreciate that in the related embodiments of the disclosure described herein, the element, step, component, or feature can also be any one of the individual recited elements, steps, components, or features, or can also be selected from a group consisting of any two or more of the explicitly listed elements, steps, components, or features. Additionally, any element, step, component, or feature recited in such a list may also be omitted from such list.

Those skilled in the art will further understand that any recitation herein of a numerical range by endpoints includes all numbers subsumed within the recited range (including fractions), whether explicitly recited or not, as well as the endpoints of the range and equivalents. The term “et seq.” is sometimes used to denote the numbers subsumed within the recited range without explicitly reciting all the numbers, and should be considered a full disclosure of all the numbers in the range. “1 to 5” includes 1, 2, 3, 4, and 5 when referring to, for example, a number of elements, and can also include, for example, 1.5, 2, 2.75, and 3.8 when referring to, values of parameters. Disclosure of a narrower range or more specific group in addition to a broader range or larger group is not a disclaimer of the broader range or larger group. All ranges disclosed herein, including those denoted by the word “between,” are inclusive of the endpoints, and the endpoints are independently combinable with each other. For example, pH ranges “between 2 and 6” are inclusive of the endpoints and all intermediate values of the range; ranges of “up to 25 wt. %, or, more specifically, 5 wt. % to 20 wt. %”, are inclusive of the endpoints and all intermediate values of the ranges, including “5 wt. % to 25 wt. %”, etc.

In certain embodiments, this disclosure relates to methods for recovering minerals such as metals, e.g., manganese, cobalt, nickel, and lithium, from mineral sources such as spent batteries. In the example of spent batteries, the methods involve leaching of spent battery material followed by precipitation of iron, aluminum, and copper impurity metals from the solution as hydroxides. Sequential solvent extraction can be subsequently performed on the solution to concentrate and purify individual metal solutions of manganese sulfate, cobalt sulfate, nickel sulfate, and lithium sulfate. Selective stripping is employed to increase a purity of extracted metals. Metals can be recovered by precipitation or evaporative crystallization. The processes can recover multiple value metals, including lithium, in a unified process with a high yield and high purity, and are suitable for use as battery precursors. This disclosure refers to “target metals” and “value metals” interchangeably. Target metals are typically targeted for extraction because they are valuable and therefore considered “value metals.” However, a metal that is targeted in one extraction process can represent an impurity in another extraction process. Accordingly, “target” and “value,” as used herein, refer to species targeted in a given process, and do not require any special characteristic of the species.

In the hydrometallurgical processing of Li-ion batteries, black mass is leached following mechanical processing to yield a multi-metal solution containing iron, aluminium, copper, manganese, cobalt, nickel, lithium, sodium, and/or ammonium. To recover metals with sufficient purity for use in battery precursors, transfer of impurities between unit operations (processing steps) can be mitigated. In many cases it is desirable to limit the transfer of impurities entirely or almost entirely. The technologies described herein provide a means of achieving the suitable purity for the production of battery-grade metal salts.

In some embodiments, the metal extraction includes a multi-stage leaching process. Impurities such as iron and aluminium are selectively leached from the black mass in a primary leach. The solid phase is depleted of iron and aluminium and enriched in manganese, cobalt, nickel, and/or lithium relative to the initial black mass. Following solid/liquid separation, the solid phase is subjected to a secondary leach where the valuable manganese, cobalt, nickel, and/or lithium report to the aqueous phase. The secondary leach uses a higher concentration of acid and/or peroxide relative to the primary leach. The aqueous phase contains lower levels of iron and aluminium relative to the primary leach. The concentration of impurities reported to downstream unit operations is thereby reduced.

Sequential solvent extraction is used to isolate individual metals following leaching. To increase the extraction of the target (value) metal in each circuit, variables such as the temperature, operating pH, phase ratio, and extractant concentration may be controlled. Even with careful control, incomplete recovery of the target metal can occur resulting in transfer to the subsequent solvent extraction circuit where it then acts as (or becomes) an impurity (nonvalue) metal. As described herein, a technique of selectively stripping metals that pass between solvent extraction circuits due to incomplete extraction improves the robustness of the process as applied to changing feed concentrations and impurity metal levels, allowing the consistent production of battery-grade materials.

Operation of multiple solvent extraction circuits in series can be facilitated by control of extractant transfer between circuits via entrainment and/or aqueous solubility. Between circuits, equipment such as after-settlers, coalescers, dual media filters, pace-setters, Jameson cells, carbon filters, or a combination of these can be used to minimize extractant losses and decrease or eliminate extractant cross-contamination.

The following examples are provided to assist one skilled in the art to further understand certain embodiments of the present disclosure. These examples are intended for illustration purposes and should not be construed as limiting the scope of the present disclosure.

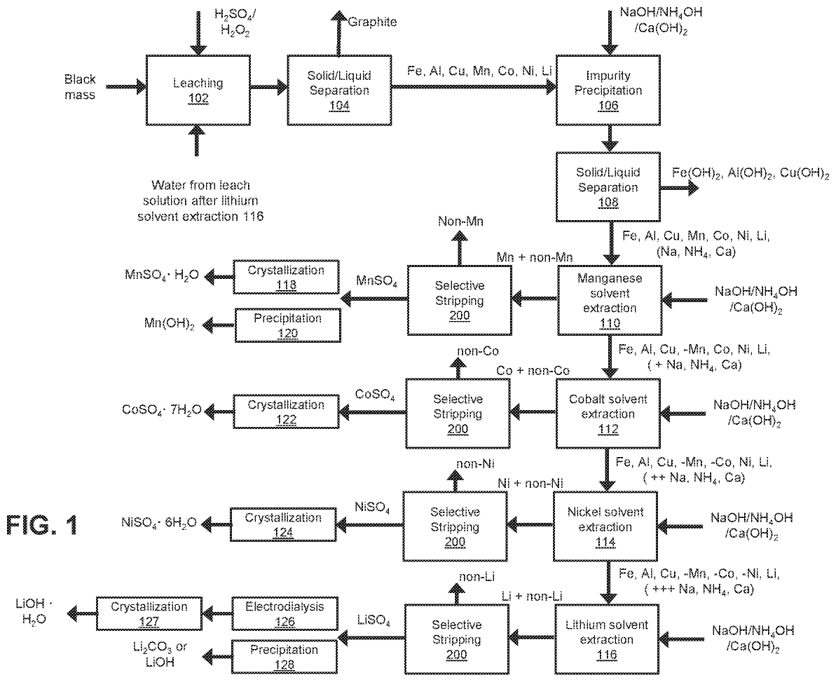

As shown in FIG. 1, process 100 provides recovery of manganese, cobalt, nickel, and/or lithium from recycled electronics and/or batteries. Process 100 can be conducted at approximately room temperature, such as between 15° C. and 30° C., though the temperature can also be outside this range for at least a portion of the process 100 in some embodiments. In some embodiments, one or more solvent extraction processes, such as cobalt solvent extraction 112, can be conducted at elevated temperatures, such as 50° C. to 70° C.

Spent battery material includes a mixture of iron, aluminum, copper, manganese, cobalt, nickel, and/or lithium. Metal ratios vary depending on the source of the spent battery and may not include all of the elements listed previously. The spent battery material is obtained following mechanical/physical separation of the electrode materials from the battery and is commonly referred to as “black mass.”

Metals in the black mass are dissolved by leaching with acid and peroxide (102). Typical conditions for the black mass, acid, and peroxide mixture are 50-300 g/L black mass, 50-300 g/L sulfuric acid, temperatures of 25-80° C., and 0-75 g/L peroxide. This transfers target metals into an aqueous solution referred to as a “leach liquor” or a “leach solution.” An example composition in grams per liter of the leach solution, and corresponding metal transfer from the black mass into the leach solution, are shown in Table 1.

TABLE 1

| | Al | Mn | Co | Ni | Cu | Li |
|---|---|---|---|---|---|---|
| Recovery % | 88.8 | 100.0 | 97.1 | 96.9 | 72.9 | 96.9 |
| Composition (gpl) | 4.29 | 6.06 | 6.59 | 20.58 | 1.15 | 3.61 |

In some embodiments, leaching (102) is conducted in a multi-stage process to reduce levels of impurities such as iron and aluminium, in the leach solution. Sulfuric acid and/or peroxide addition can be performed in a primary leach that targets aluminium, while reducing manganese, cobalt, nickel, and lithium leaching. The resulting solid phase is depleted of iron and aluminium and enriched in manganese, cobalt, nickel, and/or lithium relative to the initial black mass. The solids from the primary leach are recovered and subjected to a secondary leach targeting high manganese, cobalt, nickel, and lithium recoveries. The secondary leach uses a higher concentration of sulfuric acid and/or peroxide relative to the primary leach. The resulting secondary leach solution composition contains reduced levels of iron and aluminium relative to the primary leach solution. In some embodiments, the aluminium content in the secondary leach solution is less than 2 g/L (or “gpl”). The secondary leach solution is enriched in manganese, cobalt, nickel, and/or lithium (e.g., relative to the primary leach and/or relative to the black mass) as shown below in Table 2.

TABLE 2
Secondary leach solution metal concentration (gpl)

| Al | Co | Cu | Li | Mn | Ni |
|---|---|---|---|---|---|
| 1.7 | 7.97 | 1.75 | 3.79 | 7.23 | 23.44 |

When a leach solution has been obtained, in some embodiments an optional solid/liquid (S/L) separation process (104) is conducted to isolate liquid leach solution from solid residues by filtration. For example, simple flow filtration and/or filtering centrifugation can be conducted in order to remove solids such as graphite.

In some embodiments, non-target metals such as iron, aluminium, and/or copper are optionally at least partially removed by precipitation as metal hydroxides (106). One or more bases such as sodium hydroxide, sodium carbonate, and/or ammonium hydroxide are added to the leach solution until the pH of the leach solution is within a target pH range, such as 4-6. In some embodiments, the one or more bases include lime (e.g., calcium hydroxide, Ca(OH)₂). Addition of the bases increases the pH of the leach solution. In some embodiments, the target pH is about 5.5, such as between 5.4 and 5.6. At the target pH range, the non-target metals precipitate out as one or more metal hydroxides. The precipitation is conducted in a manner that favors precipitation of non-target metals compared to precipitation/crystallization of target metals, such as formation of manganese, cobalt, and nickel hydroxides. For example, in some embodiments the target pH range at which precipitation of non-target metals is conducted is lower than a pH range at which subsequent precipitation/crystallization of at least some target metals (such as manganese, cobalt, nickel, and/or lithium) is conducted. For example, in some embodiments proportions of one or more of the non-target metals that precipitates out as a hydroxide is larger than proportions of one or more of the target metals that precipitate out.

In some embodiments, after precipitation of the non-target metals, a solid/liquid (S/L) separation process by filtration (108) is conducted to isolate the leach solution from the hydroxide precipitates. The filtration process can include flow filtration and/or centrifugal filtration. For example, the concentrations of iron, copper, and/or aluminium in the leach solution can be reduced by filtration to less than 100 mg/L. In some embodiments, the iron, copper, and/or aluminum are reduced to concentrations less than 10 mg/L. Table 3 shows that, within a pH range of 4 to 5.5, increasing pH beneficially reduces impurity metal ions like aluminium and copper, but has less adverse effect on the concentration of value metal ions (e.g., does not significantly remove them from the leach solution or removes them less than the impurity metal ions are removed). Note, however, than the non-target metals are not entirely removed; some aluminium and copper remains in the leach solution and can be targeted in subsequent selective stripping processes.

TABLE 3
Metal concentration (gpl)

| | pH | Al | Co | Cu | Li | Mn | Ni |
|---|---|---|---|---|---|---|---|
| Leach solution | 4.02 | 1.7 | 7.97 | 1.75 | 3.79 | 7.34 | 23.44 |
| (no processing) | | | | | | | |
| Sample 1 | 4.59 | 0.283 | 7.8 | 1.26 | 3.82 | 7.27 | 23.5 |
| Sample 2 | 5.11 | 0.038 | 7.5 | 0.5 | 3.77 | 7.12 | 22.46 |
| Sample 3 | 5.5 | 0.011 | 7.41 | 0.066 | 3.82 | 7.09 | 21.67 |

In some embodiments, instead of or in addition to hydroxide precipitation extraction, one or more non-target metals are extracted from the leach solution using another method. For example, iron and/or aluminum can be extracted from the leach solution by solvent extraction using an acidic organophosphorus extractant, such as 2-ethylhexyl phosphonic acid-mono-2-ethylhexyl ester diluted in a hydrocarbon solvent to a concentration between 1-40 vol %.

In solvent extraction processes (sometimes referred to as liquid-liquid extraction processes), components are divided between two different immiscible liquids, often an aqueous liquid (polar) and an organic solvent (non-polar). Net transfer of one or more species occurs, typically from the aqueous liquid to the organic solvent and driven by chemical potentials. Various techniques can be used for solvent extraction. Single-stage solvent extraction processes can include liquid mixing followed by centrifugation. Multi-stage solvent extraction processes can include multi-stage countercurrent processing. In multi-stage countercurrent processing, the aqueous solution (containing the metal to be extracted) is flowed in an opposite direction to flow of the organic so that one or more target metals flow from the aqueous solution to the organic solvent. One output of the solvent extraction process (such as a countercurrent process) is the aqueous solution from which the one or more target metals have been removed. The other output of the solvent extraction process is the organic solvent including the one or more target metals. The target metals can then be removed from the organic solvent, e.g., by addition of one or more chemicals to the organic solvent. Removal of the target metals from the organic solvent can involve a selective stripping process, as described in more detail below.

For solvent extraction of iron and/or aluminum in a multi-stage countercurrent process, the iron and/or aluminium can be extracted into the organic phase of the solvent extraction process using the acidic organophosphorus extractant at a pH between 1 and 4, and the extracted metal(s) can be scrubbed from the organic phase using sulfuric acid. The pH for solvent extraction refers to the pH of the leach solution plus organic solvent mixture at time of extraction.

As another example of extraction of non-target metals, copper can be extracted from the leach solution by solvent extraction using a hydroxyoxime extractant such as 5-nonylsalicylaldoxime, 2-hydroxy-5-nonyl benzophenone oxime, or a solution including one or both of those chemicals. In some embodiments, an equilibrium modifier such as 2,2,4-trimethyl-1,3-pentanediol diisobutyrate or tridecanol is used together with the hydroxyoxime in the organic solvent. The extractant is diluted in a hydrocarbon solvent to a concentration between 1-40 vol %. Copper is extracted into the organic phase of the solvent extraction process at a pH between 1 and 3, and species besides the copper, such as possible impurities (e.g., iron and/or aluminium) and/or possible target metals (e.g., cobalt and/or manganese) are scrubbed from the organic phase using sulfuric acid, a copper sulfate solution, or a solution including one or both of those chemicals. Copper is selectively retained in the organic solution. Copper is then stripped from the organic solution using an aqueous solution including acid and, in some embodiments, copper sulfate. After stripping, copper can be recovered as metallic copper by electrowinning and/or as copper sulfate by evaporative crystallization. Following electrowinning or evaporative crystallization, the spent aqueous solution is depleted in copper and can be returned to the strip circuit as strip feed. In some embodiments, a portion of the spent aqueous solution is used for scrubbing.

After optional extraction of one or more non-target metals, one or more target metals are extracted in a metal-by-metal extraction sequence that includes selective stripping, as described in more detail below. In some embodiments, this extraction sequence features overall gradually-increasing pH levels of the leach solution, which can reduce reagent costs due to pH adjustment between solvent extraction circuits. The particular target metals extracted can vary in different embodiments; the sequence shown in FIG. 1 is merely an example. However, in some cases the relative order of metal extraction shown in FIG. 1 provides advantages for extraction, because the order allows for selective extraction of each target metal. This can improve the purity of extracted target metals and/or a proportion of target metals that are successfully extracted, to help achieve the purity requirements of battery-grade metal salts. This can also improve the robustness of the process 100 to variations in makeup of the feed material, e.g., varying quantities of impurities and value metals.

Following extraction of the one or more non-target metals, the leach solution includes four target metals (manganese, cobalt, nickel, and lithium) along with sodium, ammonium, and/or calcium that are in the leach solution as a remnant of the impurity precipitation 106 and/or due to the neutralization of acid. In the example process 100, manganese is isolated (110) from the cobalt, nickel, lithium, sodium, ammonium, and/or calcium. As part of manganese solvent extraction 110, one or more bases such as sodium hydroxide, ammonium hydroxide, and/or lime are added to the leach solution so that the leach solution is within a target pH range. This target pH range can be higher than a target pH range at which impurity precipitation 106 is performed and/or can be lower than respective target pH ranges at which cobalt isolation 112, nickel isolation 114, and/or lithium isolation 116 are performed. The target pH range can be a pH range at which manganese is preferentially extracted (e.g., preferentially transfers from the leach solution to the organic solvent) compared to cobalt, nickel, and/or lithium. For example, in some embodiments the pH for manganese solvent extraction is between 2 and 4.

For manganese solvent extraction 110, the organic solution can include a suitable acidic organophosphorus extractant. For example, the extractant can include di-(2-ethylhexyl)phosphoric acid (DEHPA), diluted in a hydrocarbon solvent to a concentration between 1-40 vol %. The solvent extraction can be conducted in a multi-stage countercurrent process. Selective manganese extraction can be controlled by varying base addition to the circuit, such as by saponification and/or interstage pH control. In saponification, a base is added directly to an organic solution to maintain a constant pH during extraction. In interstage pH control, a base is added between stages to neutralize acids generated during extraction and to maintain a target pH.

“Loading capacity” refers to the capacity of extractant in the organic solution to extract one or more target metals from the leach solution. For a given number of molecules of extractant, there exists a theoretical limit at which all of the extractant is bound to a target metal. In some embodiments, extraction is aided by operating at lower loading capacities compared to the theoretical limit. For example, in some embodiments, manganese extraction from the leach solution is enhanced when metal loading on the extractant is less than 70% of the extractant loading capacity, less than 50% of the extractant loading capacity, or less than 30% of the extractant loading capacity. Operating at the lower loading can promote selectivity for manganese relative to impurity metal ions. Operating at the lower loading can also provide physical benefits by reducing the tendency for extractant losses due to gelling, third phase formation, and higher aqueous solubility

In some embodiments, manganese or another target metal is not extracted alone. Rather, one or more co-extracted metals are also extracted from the leach solution, and it can be desirable to strip these co-extracted metals from the organic phase (organic solvent). In some embodiments, the co-extracted metals include iron, aluminium, and/or copper impurities. The co-extracted metals can instead or additionally include metals that were target metals earlier in the process 100. For example, manganese, which is a target metal for manganese solvent extraction 110, can be a non-target co-extracted metal for cobalt isolation 112.

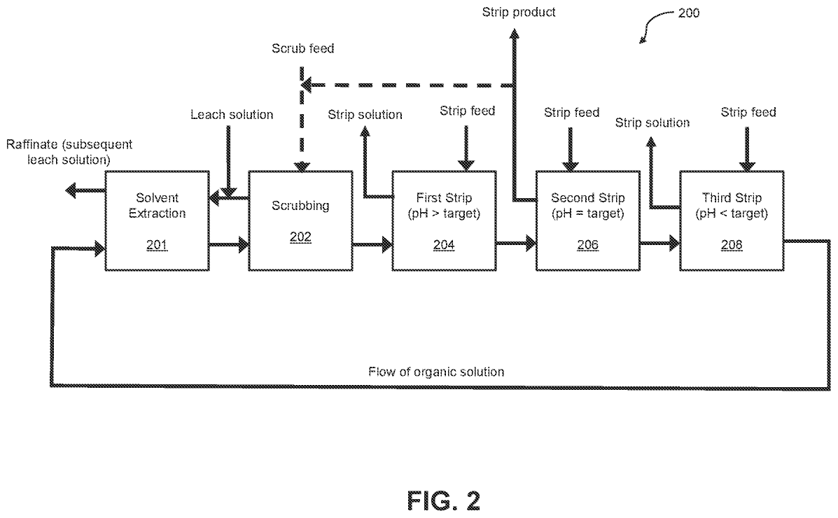

Removal of the co-extracted metals can be performed using a selective stripping process 200 as shown in FIG. 2. Selective stripping is based on the recognition that different metals are preferentially removed from the organic solution at different pH levels of the organic solution (after mixing with strip feed). Accordingly, by stripping the organic solution at progressively higher or lower pH levels, the different metals can be selectively targeted for removal to improve purities of both an extracted target metal (e.g., manganese) and one or more output products (such as re-used organic solvent). Specifically, in some embodiments of this disclosure, stripping is conducted at successive decreasing pH levels of the organic solution, which can improve selectivity compared to stripping at successive increasing pH levels. Stripping at successive increasing pH levels can result in multiple metals (both target and non-target) being removed together at the first (lowest-pH) step, reducing selectivity.

As shown in FIG. 2, solvent extraction 201 is performed on a leach solution, as described above for various target metals such as manganese solvent extraction 110. An output of solvent extraction 201 is raffinate, e.g., the leach solution with a target metal (e.g., manganese) depleted from the leach solution. The raffinate can be provided for further processing, such as extraction of one or more additional target metals (e.g., cobalt, nickel, and/or lithium) or for removal of base additives and crystallization for water recovery, as described in further detail below.

In some embodiments, the organic solution (phase) resulting from solvent extraction 201 is optionally provided for scrubbing 202. In scrubbing 202, one or more chemicals (a scrub solution) are intermixed with the organic solution to remove one or more non-target metals from the organic solution. In scrubbing, a chemical equilibrium is adjusted to favor scrubbing of the one or more non-target metals, such as by operating with an appropriate pH. The scrub solution can be recycled within the same circuit for efficiency.

In some embodiments, the scrub solution includes a dedicated scrub feed such as sulfuric acid or another sulfur-including solution. In some embodiments, the scrub solution includes a strip product (e.g., a sulfate such as manganese sulfate) resulting from stripping of the target metal in the second strip 206. In some embodiments, both the scrub feed and the strip product are used to form the scrub solution. The scrub solution added for scrubbing 202 can include, at least in part, a recycled component. For example, the scrub solution can be derived from a chemical solution remaining after evaporative crystallization containing the same target metal that is being selectively stripped in the selective stripping process 200, a chemical solution remaining after precipitation and removal of the same target metal, and/or can include a recycled portion of a strip product (strip liquor) of the same target metal. In some embodiments, the non-target metals removed in scrubbing 202 are provided back into solvent extraction 201, e.g., so that the non-target metals can be passed into the raffinate for subsequent processing.

In some embodiments, the organic solution is processed in a first strip 204 performed before a second strip 206 in which a target metal is stripped. The first strip 204 removes one or more non-target metals from the organic solution and is performed when the organic solution is at a first pH that is higher than a second pH at which the second strip 206 is performed. To perform the first strip 204, a strip feed is mixed or otherwise placed in fluidic contact with the organic solution. The strip feed includes an acidic aqueous solution, such as a sulfuric acid solution, and sets a pH at which stripping is to be performed. For a metal cation M²⁺ and extractant RH, a stripping reaction is MR₂ (organic)+2H⁺ (aqueous)→M²⁺ (aqueous)+2RH (organic). As metals are stripped, the acid is consumed and the pH increases, e.g., towards a target value.

The first pH provides preferential stripping of one or more non-target metals compared to the target metal stripped in the second strip 206. In some embodiments, the one or more non-target metals stripped in the first strip 204 are different from one or more non-target metals stripped in the third strip 208, e.g., are preferentially stripped at the first pH compared to the one or more non-target metals stripped in the third strip 208. Outputs of the first strip 204 include a strip solution including one or more metals stripped during the first strip 204, and the organic solution at least partially stripped of the one or more metals. In some embodiments, the strip solution is provided to an earlier portion of the process 100. For example, the strip solution can be provided as an input to leaching 102, a solvent extraction step (e.g., manganese solvent extraction 110), and/or impurity precipitation 106.

In the case of selective stripping targeting manganese, the first strip 204, in some embodiments, is conducted at a pH between 2 and 4 and selectively strips copper compared to at least one other target and/or non-target metal, to produce a strip solution including copper.

After the first strip 204, the organic solution is processed in a second strip 206. The second strip 206 is conducted at a second pH that is lower than the first pH at which the first strip is conducted. The second pH provides preferential stripping of the target metal compared to one or more non-target metals such as iron, aluminium, and/or an earlier or later target metal. For example, a proportion of the target metal stripped at the second pH is higher than proportions of one or more of the non-target metals stripped at the second pH. Stripping in the second strip 206 can be performed as described for the first strip 204, e.g., by addition of an acidic aqueous solution (strip feed) to obtain a pH that promotes selective extraction.

The successive pH values for selective strips according to this disclosure can differ from one another by at least 0.1, at least 0.2, at least 0.5, at least 1.0, or another value. In some embodiments, the successive pH values differ from one another by less than 5, less than 3, or less than 2.

A strip product, sometimes referred to as a strip liquor, is produced that contains the concentrated target metal. For example, the strip product can include a sulfate of the target metal. The strip product can be processed further to extract the target metal in a pure form, and/or can be provided into scrubbing 202 for further processing, e.g., to further remove non-target metals.

In the case of selective stripping targeting manganese, the second strip 206, in some embodiments, is conducted at a pH between 0 and 2. The strip product includes manganese sulfate, e.g., manganese sulfate with an ionic purity greater than 99% (e.g., as determined by inductively coupled plasma spectroscopy (ICP)). The scrub solution for selective stripping targeting manganese can include, at least in part, a manganese product recovery bleed stream, a manganese evaporative crystallization bleed stream, and/or a manganese strip product including manganese sulfate. The scrub solution can instead or additionally include a sulfate solution such as sulfuric acid.

In some embodiments, after the second strip 206, a third strip 208 is conducted at a third pH that is lower than the second pH at which the second strip 206 is conducted. The third pH provides preferential stripping of one or more non-target metals compared to the target metal stripped in the second strip 206. In some embodiments, the one or more non-target metals stripped in the third strip 208 are different from the one or more non-target metals stripped in the first strip 204, e.g., are preferentially stripped at the third pH compared to the one or more non-target metals stripped in the first strip 204. The third strip 208 can be conducted as described for the first strip 204, e.g., by use of an added strip feed. Strip solution output by the third strip 208 can be provided to one or more earlier steps of the process 100, as described for the first strip 204. For example, the strip solution can be provided as an input to leaching 102, a solvent extraction step (e.g., manganese solvent extraction 110), and/or impurity precipitation 106. The organic solution remaining after the third strip 208 can be provided back to solvent extraction 201 as organic solution, to remove metals from leach solution as described above.

In the case of selective stripping targeting manganese, the third strip 208, in some embodiments, is conducted at a pH between −0.8 and 1 and selectively strips iron and/or aluminium compared to at least one other target and/or non-target metal, to produce strip solution including iron and/or aluminum.

Selective stripping can, but need not, include both a first strip 204 and a third strip 208. Rather, in some embodiments the second strip 206 and either the first strip 204 or the third strip 208 are conducted. The selective stripping (including both the order of stripping and the relative pHs of stripping) allows for selective removal of non-target and target metals in order to obtain more pure strip products of the target metal. Alternative orders and/or pHs could, in some cases, lead to excessive removal of the target metal in a strip solution output by the first strip 204 or the third strip 208, and/or could lead to excess non-target metals output in the strip product from the second strip 206. Accordingly, selective stripping as described herein can improve the purity of extracted target metals and/or a proportion of target metals that are successfully extracted, to help achieve the purity requirements of battery-grade metal salts. Selective stripping can also improve the robustness of the process 100 to variations in makeup of the feed material, e.g., varying quantities of impurities and value metals.

Referring again to FIG. 1, the strip product including manganese sulfate, as output from the second strip 206, is processed to recover a manganese product. In some embodiments, evaporative crystallization 118 of the manganese strip product (including, e.g., manganese sulfate) is conducted, to recover a manganese sulfate product. In some embodiments, one or more bases (e.g., sodium hydroxide, ammonium hydroxide, and/or lime) are added to the manganese strip product in a precipitation process 120, to form solid manganese hydroxide which can be recovered by filtration.

Leach solution output from manganese solvent extraction 110 (raffinate from solvent extraction 201) includes remaining target metals cobalt, nickel, and lithium, along with, in some embodiments, a reduced amount of manganese, and increased sodium, ammonium, and/or calcium due to addition of bases at manganese solvent extraction 110. The leach solution can include one or more non-target metals such as iron, aluminium, and/or copper. This leach solution is provided for cobalt solvent extraction 112. In cobalt solvent extraction 112, cobalt is isolated from the leach solution using an organic solution including any suitable acidic organophosphorus extractant. For example, in some embodiments the extractant includes bis(2,4,4-trimethylpentyl)phosphinic acid (available from Solvay S.A. as CYANEX® 272) diluted in a hydrocarbon solvent to a concentration between 1-40 vol %. Cobalt solvent extraction 112 can be conducted in a multi-stage countercurrent process at a higher pH than the pH used for manganese solvent extraction 110, the pH being controlled by addition of one or more bases. For example, in some embodiments the pH for cobalt solvent extraction is between 4 and 6. This pH can be lower than one or more pH values used for subsequent solvent extraction, e.g., of nickel and/or lithium. As described for manganese solvent extraction 110, in some embodiments cobalt solvent extraction 112 is conducted at a lower-than-100% loading capacity of the extractant. For example, in some embodiments, metal loading on the extractant is less than 70% of the extractant loading capacity, less than 50% of the extractant loading capacity, or less than 3% of the extractant loading capacity. In cobalt solvent extraction 112, cobalt is separated from nickel, lithium, sodium, ammonium, and/or calcium into the organic solution. Co-extractants besides cobalt can also be transferred into the organic solution.

The extracted metals in the organic solution can be subject to selective stripping 200, e.g., as described above for manganese. The selective stripping 200 includes a second strip 206 targeting cobalt and one or both of a first strip 204 or a third strip 208 conducted at, respectively, higher and lower pH than the pH of the second strip 206 and conducted, respectively, before and after the second strip 206. The first strip 204 and third strip 208 are selective for one or more non-target metals compared to cobalt and/or one or more other non-target metals because of the respective pH levels at which they are conducted. In some embodiments, for cobalt extraction, the first strip 204 can be conducted at a first pH between 5 and 6, the second strip 206 can be conducted at a second pH between 2 and 5, and the third strip 208 can be conducted at a third pH lower than the second pH, e.g., between −0.5 and 3. In some embodiments, for cobalt extraction, the first strip 204 selectively strips nickel, lithium, calcium, sodium, and/or ammonium. In some embodiments, for cobalt extraction, the third strip 208 selectively strips manganese and/or copper. Strip solutions from the first strip 204 and third strip 208 can be provided into an earlier portion of the process 100, as described above. The scrub solution for selective stripping targeting cobalt can include, at least in part, a cobalt product recovery bleed stream, a cobalt evaporative crystallization bleed stream, and/or a cobalt strip product including cobalt sulfate. The scrub solution can instead or additionally include a sulfur solution such as sulfuric acid.

Cobalt sulfate in the strip product resulting from the second strip 206 can have an ionic purity greater than 99.9%. Cobalt can be recovered from the strip product exiting the second strip 206 by evaporative crystallization 122 to obtain a cobalt sulfate heptahydrate product.

Leach solution output from cobalt solvent extraction 112 (raffinate from solvent extraction 201) includes remaining target metals nickel and lithium, along with, in some embodiments, a reduced amount of manganese and/or cobalt, and increased sodium, ammonium, and/or calcium due to addition of bases at cobalt solvent extraction 112. This leach solution is provided for nickel solvent extraction 114. In nickel solvent extraction 114, nickel is isolated from the leach solution using an organic solution including any suitable organophosphorus acid, carboxylic acid, hydroxyoxime or a mixture thereof. In some embodiments, a modifier is added to the organic phase, such as 2,2,4-trimethyl-1,3-pentanediol diisobutyrate, tridecanol, and/or a neutral organophosphorus donor as an equilibrium or third phase modifier. The organic solution can include neodecanoic acid diluted in a hydrocarbon solvent to a concentration between 1-40 vol %. Nickel solvent extraction 114 can be conducted in a multi-stage countercurrent process at a higher pH than the pH used for manganese solvent extraction 110 and/or the pH used for cobalt solvent extraction 112, the pH being controlled by addition of one or more bases. For example, in some embodiments the pH for nickel solvent extraction is between 5 and 7 This pH can be lower than one or more pH values used for subsequent solvent extraction, e.g., of lithium. As described for manganese solvent extraction 110, in some embodiments nickel solvent extraction 114 is conducted at a lower-than-100% loading capacity of the extractant. For example, in some embodiments, metal loading on the extractant is less than 70% of the extractant loading capacity, less than 50% of the extractant loading capacity, or less than 30% of the extractant loading capacity. In nickel solvent extraction 114, nickel is separated from lithium, sodium, ammonium, and/or calcium into the organic solution. Co-extractants besides nickel can also be transferred into the organic solution.

The extracted metals in the organic solution can be subject to selective stripping 200, e.g., as described above for manganese and cobalt. The selective stripping 200 includes a second strip 206 targeting nickel and one or both of a first strip 204 or a third strip 208 conducted at, respectively, higher and lower pH than the pH of the second strip 206 and conducted, respectively, before and after the second strip 206. The first strip 204 and third strip 208 are selective for one or more non-target metals compared to nickel and/or one or more other non-target metals because of the respective pH levels at which they are conducted. In some embodiments, for nickel extraction, the first strip 204 can be conducted at a first pH between 5.5 and 7, the second strip 206 can be conducted at a second pH between 1 and 5 (e.g., between 1.5 and 5), and the third strip 208 can be conducted at a third pH between 1 and 4. In some embodiments, for nickel extraction, the first strip 204 selectively strips cobalt. In some embodiments, for nickel extraction, the third strip 208 selectively strips copper, aluminum, and/or iron. Strip solutions from the first strip 204 and third strip 208 can be provided into an earlier portion of the process 100, as described above. The scrub solution for selective stripping targeting nickel can include, at least in part, a nickel product recovery bleed stream, a nickel evaporative crystallization bleed stream, and/or a nickel strip product including nickel sulfate. The scrub solution can instead or additionally include a sulfur solution such as sulfuric acid.

Nickel sulfate in the strip product resulting from the second strip 206 can have an ionic purity greater than 99.9%. Nickel can be recovered from the strip product exiting the second strip 206 by evaporative crystallization 124 to obtain a nickel sulfate hexahydrate product.

Leach solution output from nickel solvent extraction 114 (raffinate from solvent extraction 201) includes remaining target metal lithium, along with, in some embodiments, a reduced amount of manganese, cobalt, and/or nickel, and increased sodium, ammonium, and/or calcium due to addition of bases at nickel solvent extraction 114. The leach solution can include one or more non-target metals such as iron, aluminium, and/or copper. This leach solution is provided for lithium solvent extraction 116. In lithium solvent extraction 116, lithium is isolated from the leach solution using an organic solution including a proton donating agent (such as an alcohol, ketone (e.g., beta-diketone), aldehyde, fatty acid, or a mixture thereof), and neutral organophosphorus donor, such as a phosphine oxide (available from Solvay S.A. as CYANEX® 936P). The extractant can be diluted in a hydrocarbon solvent to a concentration between 1-40 vol %. Lithium solvent extraction 116 can be conducted in a multi-stage countercurrent process at a higher pH than the pH used for manganese solvent extraction 110, the pH used for cobalt solvent extraction 112, and/or the pH used for nickel solvent extraction 114, the pH being controlled by addition of one or more bases. For example, in some embodiments the pH for lithium solvent extraction is between 9 and 12. As described for manganese solvent extraction 110, in some embodiments lithium solvent extraction 116 is conducted at a lower-than-100% loading capacity of the extractant. For example, in some embodiments, metal loading on the extractant is less than 70% of the extractant loading capacity, less than 50% of the extractant loading capacity, or less than 30% of the extractant loading capacity. In lithium solvent extraction 116, lithium is separated from sodium, ammonium, and/or calcium into the organic solution. Co-extractants besides lithium can also be transferred into the organic solution.

The extracted metals in the organic solution can be subject to selective stripping 200, e.g., as described above for manganese, cobalt, and nickel. The selective stripping 200 includes a second strip 206 targeting lithium and one or both of a first strip 204 or a third strip 208 conducted at, respectively, higher and lower pH than the pH of the second strip 206 and conducted, respectively, before and after the second strip 206. The first strip 204 and third strip 208 are selective for one or more non-target metals compared to lithium and/or one or more other non-target metals because of the respective pH levels at which they are conducted. In some embodiments, for lithium extraction, the first strip 204 can be conducted at a first pH between 10 and 12, the second strip 206 can be conducted at a second pH between 1 and 7 (e.g., 1.5 to 7), and the third strip 208 can be conducted at a third pH between 1 and 6. In some embodiments, for lithium extraction, the first strip 204 selectively strips sodium, and/or ammonium. In some embodiments, for lithium extraction, the third strip 208 selectively strips nickel and/or calcium. Strip solutions from the first strip 204 and third strip 208 can be provided into an earlier portion of the process 100, as described above. The scrub solution for selective stripping targeting lithium can include, at least in part, a lithium product recovery bleed stream, a lithium electrodialysis or evaporative crystallization bleed stream, and/or a lithium strip product including lithium sulfate. The scrub solution can instead or additionally include a sulfur solution such as sulfuric acid.

Lithium sulfate in the strip product resulting from the second strip 206 can have an ionic purity greater than 95%. Lithium can be recovered from the strip product exiting the second strip 206 by electrodialysis 126 to obtain aqueous LiOH, followed by evaporative crystallization 127 to obtain lithium hydroxide monohydrate, and/or precipitation 128 can be performed by adding one or more carbonate and/or hydroxide bases, to obtain lithium carbonate and/or lithium hydroxide.

After lithium solvent extraction 116, the spent leach solution can be processed by evaporative crystallization to obtain residuals of the added base chemicals, such as sodium sulfate, ammonium sulfate, and or calcium sulfate. In some embodiments, the water vapor recovered during evaporative crystallization can be condensed and re-used in the process 100, such as contributing to the aqueous base at leaching 102.

In view of the above description and the examples, one of ordinary skill in the art will be able to practice the described technologies without undue experimentation.

Although a few embodiments have been described in detail above, other modifications are possible. Logic flows depicted in the figures do not require the particular order shown, or sequential order, to achieve desirable results, unless indicated otherwise. In addition, other actions may be provided, or actions may be eliminated, from the described flows, and other components may be added to, or removed from, the described systems. Accordingly, other embodiments are within the scope of the following claims. For example, although examples of selective strips with two or three strip stages have been provided, in some embodiments a number of stages of a selective strip can be four or more, with pHs of the stages decreasing for each stage in temporal sequence. For example, although a process including manganese, cobalt, nickel, and lithium extraction is described, the process need not include each of these target metals. For example, after extraction of manganese, the process can continue to nickel or lithium extraction without extraction of cobalt and/or nickel. Instead or additionally, processes can include extraction of one or more additional metals.

We claim:

1. A hydrometallurgical solvent extraction process, comprising:
intermixing an aqueous acidic feed stream comprising mixed metal ions with an organic solvent comprising a first metal extraction reagent that is selective to binding a first target metal ion species, to extract the first target metal ion species into the organic solvent and obtain a loaded organic solvent comprising the first target metal ion species and one or more non-target metal ion species;
selectively stripping the loaded organic solvent, wherein selectively stripping the loaded organic solvent comprises
intermixing the loaded organic solvent with a second aqueous acidic strip solution at a second pH, to transfer the first target metal ion species from the loaded organic solvent to the second aqueous acidic strip solution, and
(i) prior to intermixing the loaded organic solvent with the second aqueous acidic strip solution, intermixing the loaded organic solvent with a first aqueous acidic strip solution at a first pH that is greater than the second pH, to transfer a first non-target metal ion species of the one or more non-target metal ion species to the first aqueous acidic strip solution, or
(ii) subsequent to intermixing the loaded organic solvent with the second aqueous acidic strip solution, intermixing the loaded organic solvent with a third aqueous acidic strip solution at a third pH that is less than the second pH, to transfer a second non-target metal ion species of the one or more non-target metal ion species to the third aqueous acidic strip solution, or
both (i) and (ii); and
recovering the first target metal ion species from the second aqueous acidic strip solution.

2. The process of claim 1, wherein
(a) intermixing the loaded organic solvent with the first aqueous strip acidic solution at the first pH selectively removes the first non-target metal ion species compared to at least one of the first target metal ion species or the second non-target metal ion species, or
(b) intermixing the loaded organic solvent with the third aqueous acidic solution at the third pH selectively removes the second non-target metal ion species compared to at least one of the first target metal ion species or the first non-target metal ion species, or
both (a) and (b).

3. The process of claim 1, wherein
(a) the second pH is at least 0.5 less than the first pH, or
(b) the second pH is at least 0.5 more than the third pH, or
both (a) and (b).

4. The process of claim 1, wherein the second pH is between 0 and 2, and
(a) the first pH is between 2 and 5, or
(b) the third pH is between −0.8 and 1, or
both (a) and (b).

5. The process of claim 1, wherein the second pH is between 2 and 5, and
(a) the first pH is between 5 and 6, or
(b) the third pH is between −0.5 and 3, or
both (a) and (b).

6. The process of claim 1, wherein the second pH is between 1.5 and 5, and
(a) the first pH is between 5.5 and 7, or
(b) the third pH is between 1 and 4, or
both (a) and (b).

7. The process of claim 1, wherein the second pH is between 1.5 and 7, and
(a) the first pH is between 10 and 12, or
(b) the third pH is between 1 and 6, or
both (a) and (b).

8. The process of claim 1, wherein the aqueous acidic feed stream is derived from at least one of recycled electronics or recycled battery materials, and
wherein the aqueous acidic feed stream comprises one or more of manganese, cobalt, nickel, or lithium metal ions.

9. The process of claim 1, wherein the first target metal ion species comprises manganese, and
(a) the first non-target metal ion species comprises copper, or
(b) the second non-target metal ion species comprises at least one of iron or aluminium, or
both (a) and (b).

10. The process of claim 1, wherein the first target metal ion species comprises cobalt, and
(a) the first non-target metal ion species comprises at least one of nickel, lithium, calcium, sodium, or ammonium, or
(b) the second non-target metal ion species comprises at least one of manganese or copper, or
both (a) and (b).

11. The process of claim 1, wherein the first target metal ion species comprises nickel, and
(a) the first non-target metal ion species comprises cobalt, or
(b) the second non-target metal ion species comprises at least one of copper, aluminum, or iron, or
both (a) and (b).

12. The process of claim 1, wherein the first target metal ion species comprises lithium, and
(a) the first non-target metal ion species comprises at least one of sodium or ammonium, or
(b) the second non-target metal ion species comprises at least one of nickel or calcium, or
both (a) and (b).

13. The process of claim 1, wherein a loading capacity of the first metal extraction reagent is less than 70%.

14. The process of claim 1, wherein recovering the first target metal ion species comprises crystallizing a sulfate hydrate product out of the second aqueous acidic strip solution.

15. The process of claim 1, wherein the first metal extraction reagent comprises an organophosphorus compound.

16. The process of claim 15, wherein the organophosphorus compound comprises di-(2-ethylhexyl)phosphoric acid.

17. The process of claim 1, comprising:
subsequent to intermixing the aqueous acidic feed stream with the organic solvent comprising the first metal extraction reagent, intermixing the aqueous acidic feed stream with a second organic solvent comprising a second metal extraction reagent that is selective to binding a second target metal ion species, to extract the second target metal ion species into the second organic solvent,
wherein intermixing with the second organic solvent is conducted at a higher pH than intermixing with the organic solvent.

18. The process of claim 1, comprising obtaining the aqueous acidic feed stream comprising mixed-metal ions by:
performing a primary leach of black mass solids, wherein metal ion impurities are selectively leached from the black mass solids into a first leaching solution;
performing first solid/liquid separation of the black mass solids and the first leaching solution;
performing a secondary leach of the black mass solids, wherein value metal ions are selectively leached from the black mass solids into a secondary leaching solution; and
performing second solid/liquid separation of the black mass solids and the secondary leaching solution, to isolate the secondary leaching solution enriched in the value metal ions.

19. The process of claim 1, comprising:
removing metal ion impurities comprising at least one of iron, copper, or aluminium from the aqueous acidic feed stream by at least one of
precipitating the metal ion impurities from the aqueous acidic feed stream as metal hydroxides and separating the precipitated metal hydroxides from the aqueous acidic feed stream by filtering, or
intermixing the aqueous acidic feed stream with a second organic solvent comprising a metal extraction reagent that is selective to binding the metal ion impurities, so transfer the metal ion impurities into the second organic solvent.

20. The process of claim 1, comprising:
prior to selectively stripping the loaded organic solvent, intermixing the loaded organic solvent with a scrubbing solution comprising at least one of sulfuric acid or a sulfate of the first target metal ion species; and
removing one or more metal ion impurities from the loaded organic solvent intermixed with the scrubbing solution.

21. The process of claim 1, comprising providing the loaded organic solvent for further solvent extraction after extraction of the first target metal ion species and the one or more non-target metal ion species from the loaded organic solvent.

22. A process for extracting target metal ion species from at least one of recycled electronics or recycled battery materials, the process comprising:
obtaining a leach solution comprising manganese ions, cobalt ions, nickel ions, and lithium ions, wherein the leach solution is derived from the at least one of recycled electronics or battery materials dissolved with at least one of acid or a reducing agent;
separating the manganese ions from the leach solution in a first multi-stage hydrometallurgical solvent extraction process using a first organic solution and conducted at a first pH;
subsequent to separating the manganese ions from the leach solution, separating the cobalt ions from the leach solution in a second multi-stage hydrometallurgical solvent extraction process using a second organic solution and conducted at a second pH that is higher than the first pH;
subsequent to separating the cobalt ions from the leach solution, separating the nickel ions from the leach solution in a third multi-stage hydrometallurgical solvent extraction process using a third organic solution and conducted at a third pH that is higher than the second pH; and
subsequent to separating the nickel ions from the leach solution, separating the lithium ions from the leach solution in a fourth multi-stage hydrometallurgical solvent extraction process using a fourth organic solution and conducted at a fourth pH that is higher than the third pH.

23. The process of claim 22, wherein the first pH is between 2 and 4, the second pH is between 4 and 6, the third pH is between 5 and 7, and the fourth pH is between 9 and 12.

24. The process of claim 22, wherein:
(a) the first organic solution comprises di-(2-ethylhexyl)phosphoric acid, or
(b) the second organic solution comprises bis(2,4,4-trimethylpentyl)phosphinic acid; or
(c) the third organic solution comprises carboxylic acid compound; or
(d) the fourth organic solution comprises a phosphine oxide and a proton donating agent; or
a combination of (a), (b), (c), or (d).

25. The process of claim 24, wherein the proton donating agent is a ketone.

26. The process of claim 25, wherein the ketone is a beta-diketone.

27. The process of claim 22, wherein separation of the manganese ions, cobalt ions, nickel ions, and lithium ions is conducted with metal loading capacities of metal extraction reagents of less than 70%.

28. The process of claim 22, comprising converting at least one of the manganese ions, cobalt ions, nickel ions, or lithium ions into a metal salt form by crystallization.

29. The process of claim 22, comprising:
scrubbing at least one of the first organic solution, the second organic solution, the third organic solution, or the fourth organic solution following respective metal ion separation processes, wherein the scrubbing comprises intermixing the respective organic solution with a scrubbing solution comprising at least one of sulfuric acid or a metal sulfate.

30. The process of claim 29, wherein the metal sulfate is derived from an evaporative crystallization bleed stream or a bleed stream from a stripping process.

31. The process of claim 22, comprising controlling pH levels of the leach solution from the first pH, to the second pH, to the third pH, and to the fourth pH by flowing one or more bases into the leach solution.

32. The process of claim 31, comprising recovering at least one of sodium ions, ammonium ions, or calcium ions from the leach solution after separation of the lithium ions, by:
performing evaporative crystallization on the leach solution to yield at least one of sodium sulfate salts ammonium sulfate salts, or calcium sulfate salts.

33. The process of claim 32, comprising:
obtaining water as a product of the evaporative crystallization; and
providing the water as a base for generation of subsequent leach solution of additional black mass.
